(19) United States
(12) Patent Application Publication
(10) Pub. No.: US 2017/0244933 A1
(43) Pub. Date: Aug. 24, 2017

(54) LOW-COST, COMPACT SECURITY MONITORING

(71) Applicant: RSI Video Technologies, Inc., Vadnais Heights, MN (US)

(72) Inventors: Jean-Michel Reibel, Vadnais Heights, MN (US); Sami Saad, Vadnais Heights, MN (US)

(21) Appl. No.: 15/471,721

(22) Filed: Mar. 28, 2017

Related U.S. Application Data
(62) Division of application No. 14/249,224, filed on Apr. 9, 2014.
(60) Provisional application No. 61/810,245, filed on Apr. 9, 2013.
(60) Provisional application No. 61/810,247, filed on Apr. 9, 2013.

(51) Int. Cl. H04N 7/18; H04N 5/225

(52) U.S. Cl. CPC H04N 7/18; H04N 5/2251; G08B 13/19636

(57) ABSTRACT

Aspects of the present disclosure are directed toward methods, systems and apparatuses that include a main printed circuit board with first-type sensor circuitry and another printed circuit board with second-type sensor circuitry. One of the main printed circuit board and the other printed circuit board is adjustable or set relative to the other of the main printed circuit board and the other printed circuit board. Additionally, a connector is provided that adjusts one of the main printed circuit board and the other printed circuit board relative to the other of the main printed circuit board and the other printed circuit board, which adjusts a field of view of the first-type sensor circuitry relative to the second-type sensor circuitry.

### BACKGROUND

In order to protect residents, employees, personal property, and the like, security monitoring systems are used to monitor a variety of facilities and to sense the presence of an unwanted intruder. A home/office monitoring security system can include a combination of sensing devices, alarm devices, and/or cameras.

These and other matters have presented challenges to different types of communications, for a variety of applications.

### SUMMARY

Aspects of the present disclosure are directed toward apparatuses that include a main printed circuit board with first-type sensor circuitry and another printed circuit board with second-type sensor circuitry. Additionally, one of the main printed circuit board and the other printed circuit board includes a passive infrared (PIR) sensor that is adjustable or set relative to the other of the main printed circuit board and the other printed circuit board. The apparatuses also include a connector that adjusts one of the main printed circuit board and the other printed circuit board relative to the other of the main printed circuit board and the other printed circuit board. This adjusts a field of view of the first-type sensor circuitry relative to the second-type sensor circuitry.

In certain specific embodiments, at least one of the first-type sensor circuitry and the second-type sensor circuitry interacts with a wide angle lens, infrared light emitting diodes (LEDs), and circuitry configured and arranged to transmit a status signal including monitoring information. Further, in other specific embodiments, a housing is provided that supports and contains the main printed circuit board the other printed circuit board.

Other aspects of the present disclosure are directed toward methods that include providing a main printed circuit board with first-type sensor circuitry and another printed circuit board with second-type sensor circuitry. One of the main printed circuit board and the other printed circuit board includes a PIR sensor that is adjustable or set relative to the other of the main printed circuit board and the other printed circuit board. Additionally, at least one of the first-type sensor circuitry and the second-type sensor circuitry interacts with a wide angle lens, LEDs, and circuitry configured and arranged to transmit a status signal including monitoring information. The methods also include providing a connector to adjust one of the main printed circuit board and the other printed circuit board relative to the other of the main printed circuit board and the other printed circuit board, and adjust a field of view of the first-type sensor circuitry relative to the second-type sensor circuitry. Further, the methods include securing the main printed circuit board the other printed circuit board to a housing.

The above discussion/summary is not intended to describe each embodiment or every implementation of the present disclosure. The figures and detailed description that follow also exemplify various embodiments.

### BRIEF DESCRIPTION OF THE DRAWINGS

Various example embodiments may be more completely understood in consideration of the following detailed description in connection with the accompanying drawings, in which:

FIG. 1A shows a top down view of an apparatus including multiple printed circuit boards, consistent with various aspects of the present disclosure;

FIG. 1B shows a side view of an apparatus including multiple printed circuit boards, consistent with various aspects of the present disclosure;

FIG. 1C shows an exterior of an apparatus, consistent with various aspects of the present disclosure;

FIG. 2 shows an example security monitoring device and sensing range of a passive infrared sensor and a camera contained within the security monitoring device, consistent with various aspects of the present disclosure;

FIG. 3 shows another example security monitoring device and sensing range of a passive infrared sensor and a camera contained within the security monitoring device, consistent with various aspects of the present disclosure;

FIG. 4A shows an example security system with controlled remote video access, consistent with various aspects of the present disclosure;

FIG. 4B shows another example security system with controlled remote video access, consistent with various aspects of the present disclosure;

FIGS. 5A-5F show example printed circuit board structures, consistent with various aspects of the present disclosure;

FIG. 6 shows a flowchart of an example method of manufacture, consistent with various aspects of the present disclosure;

FIG. 7 shows an example battery terminal interface circuit, consistent with various aspects of the present disclosure; and

FIG. 8 shows an example operational flowchart, consistent with various aspects of the present disclosure.

While the disclosure is amenable to various modifications and alternative forms, specifics thereof have been shown by way of example in the drawings and will be described in detail. It should be understood, however, that the disclosure is not limited only to the particular embodiments described. On the contrary, the disclosure is to cover all modifications, equivalents, and alternatives falling within the scope of the disclosure including aspects defined in the claims. In addition, the term “example,” as used throughout this application, is only by way of illustration, and not limitation.

### DETAILED DESCRIPTION

Various aspects of the present disclosure are directed toward low-cost compact security monitoring apparatus, methods of using such apparatus, and methods of manufacturing such apparatus.

Various aspects of the present disclosure are directed toward an apparatus having a main printed circuit board with first circuitry and a secondary printed circuit board with second circuitry. One of the main printed circuit board and the secondary printed circuit board includes a passive infrared (PIR) sensor that is adjustable relative to the other of the main printed circuit board and the secondary printed circuit board. In certain embodiments, the circuitry of the main printed circuit board and the secondary printed circuit board are provided on a single side of the main printed circuit board and the secondary printed circuit board. Additionally, other embodiments of the present disclosure include an apparatus that is powered by at least one battery (e.g., a lithium ion battery). In yet other embodiments, the apparatus is powered by a battery terminal interface circuit that is wired to a power source. In other embodiments, two batteries are provided to an apparatus, and these batteries are disposed laterally on the sides of one of the main printed circuit board and the secondary printed circuit board.

In certain embodiments, a structure is provided to the apparatus in order to rotate or shift one of the main printed circuit board and the secondary printed circuit board, relative to the other of the main printed circuit board and the secondary printed circuit board. The structure can be flexible in certain embodiments. Further, in other embodiments, at least one of the first circuitry and the second circuitry interacts with a wide angle lens, infrared light emitting diodes (LEDs), a standard motion coverage lens, and circuitry configured and arranged to transmit a status signal including monitoring information. Additionally, the apparatus can be provided in a housing to secure one or more of the above noted items. In such embodiments, an attachment mechanism can be provided to the housing in order to allow for flat wall mounting of the apparatus. In other embodiments, attachment mechanisms can be provided to the housing to allow for corner mounting of the apparatus.

Various apparatuses, consistent with various aspects of the present disclosure, also include a flex-element attached on a circuitry-containing side of both the main printed circuit board and the secondary printed circuit board. The flex-element electrically connects the printed circuit boards, and is also provided to rotate or shift one of the main printed circuit board and the secondary printed circuit board, relative to the other of the main printed circuit board and the secondary printed circuit board. Additionally, a varnish layer can be provided on the circuitry-containing side of both the main printed circuit board and the secondary printed circuit board. The varnish layer provides protection to the main printed circuit board and the secondary printed circuit board against environmental elements such as humidity and moisture.

Additionally, in certain embodiments, the apparatus is provided with at least one infrared light emitting diode and an imaging arrangement. Further, various embodiments of the apparatus are described in that at least one of the first circuitry and the second circuitry includes a compression circuitry configured and arranged to compress images captured by the imaging arrangement. Moreover, one of the first circuitry and the second circuitry can include microcontroller circuitry to control at least one of the imaging arrangement and at least one infrared light emitting diode. Various embodiments of the present disclosure include one of the first circuitry and the second circuitry that has wireless connectivity circuitry to communicate with a control station.

Various aspects of the present disclosure are also directed toward an assembly including multiple components. In certain embodiments, the assembly includes a main printed circuit board with first circuitry and a secondary printed circuit board with second circuitry. Additionally, one of the main printed circuit board and the secondary printed circuit board includes a passive infrared (PIR) sensor that is adjustable relative to the other of the main printed circuit board and the secondary printed circuit board. The assembly also includes an image capturing arrangement, at least one infrared light emitting diode, and wireless transmitting/receiving circuitry.

Various aspects of the present disclosure are also directed toward apparatus including a multiple printed circuit board (PCB) assembly. The multiple printed circuit board (PCB) assembly includes a first PCB and a second PCB. Additionally, the multiple printed circuit board (PCB) assembly has one or more light emitting diodes (LEDs) arranged on one of the first PCB or the second PCB. Further, the multiple printed circuit board (PCB) assembly includes a passive IR (PIR) detection circuit arranged on one of the first PCB or the second PCB. The multiple printed circuit board (PCB) assembly is also provided with a logic circuit on one of the first and second PCBs, and a wireless communication circuit on one of the first and second PCBs. The first PCB and the second PCB are connected by a connector that provides an electrical connection between the first and second PCBs.

In certain embodiments, apparatus of the present disclosure are further characterized in that the first PCB and the second PCB are oriented in respective planes that intersect at an angle. Additionally, the multiple printed circuit board (PCB) assembly also includes a camera configured and arranged on one of the first and second PCBs. In various embodiments, the connector is a flexible connector. Certain embodiments of apparatus of the present disclosure also include a motor having a first arm coupled to the first PCB and a second arm coupled to the second PCB. The motor adjusts placement of the first PCB relative to the second PCB in response to the logic circuit. In certain more specific embodiments, the logic circuit includes a processor that causes the camera to capture images in response to the PIR detection circuit. In other embodiments, the logic circuit also includes a data compression circuit that compresses images captured by the camera.

Certain embodiments of the apparatus are further characterized in that the wireless communication circuit transmits images compressed by the data compression circuit. Additionally, in certain embodiments, the multiple PCB assembly also includes a battery receptacle on or near the first PCB that connects a battery to one or more circuits on the first PCB. In other embodiments, a battery elimination circuit is provided and coupled to the one or more circuits on the first PCB via the battery receptacle. The battery elimination circuit provides power from a power supply to the one or more circuits.

Other embodiments of the apparatus of the present disclosure include a protective coating on the multiple PCB assembly. The protective coating protects the first PCB and the second PCB against environmental elements such as humidity and moisture. Apparatus of the present disclosure can also include a housing that contains the multiple PCB assembly. The housing can include a respective hole/aperture for each of the one or more LEDs, and a hole/aperture for a camera included in the multiple PCB assembly. The housing can also orient the first PCB at an angle with respect to the second PCB. Additionally, the LEDs can be coupled to the first PCB by a respective spring connection.

Further, in certain embodiments, the logic circuit controls the one or more LEDs, a camera included in the multiple PCB assembly, and the wireless communication circuit in response to the PIR detection circuit. Additionally, the logic circuit can transmit data or a status signal to a remote server via the wireless communication circuit.

Various aspects of the present disclosure are also directed towards methods of manufacturing an apparatus. These methods include a first printed circuit board (PCB) and a second PCB. A first set of components is soldered on an upward facing side of the first PCB, and a second set of components is soldered on an upward facing side of the second PCB. Additionally, a flexible connector is provided (to connect the two PCBs). A first end of the flexible connector is soldered to the first PCB, and a second end of the flexible connector is soldered to the second PCB. The first and second PCBs are situated on a housing, and the orientation of the first PCB, with reference to the second PCB, can be adjusted. In certain more specific embodiments, the apparatus is used to test functionality of the first and second sets of components.

Various aspects of the present disclosure are also directed towards methods of manufacturing an apparatus. These methods include a first printed circuit board (PCB) and a second PCB. A first set of components is provided on an upward facing side of the first PCB, and a second set of components is provided on an upward facing side of the second PCB. Additionally, a flexible connector is provided (to connect the two PCBs). A first end of the flexible connector is provided to the first PCB, and a second end of the flexible connector is provided to the second PCB. The first and second PCBs are situated on a housing, and orientation of the first PCB with reference to the second PCB is adjusted. In certain more specific embodiments, the apparatus is used to test functionality of the first and second sets of components.

Various aspects of the present disclosure are also directed towards methods that include providing a monitoring device, including a housing and two printed circuit boards (PCBs). The two PCBs being connected electrically by a connector and one of the PCBs includes a PIR, and one of the two PCBs being oriented at an angle with respect to the other one of the PCBs. The method also includes installing the monitoring device at a location to monitor a target area, wherein a light emitting diode on one of the two PCB boards directs light to a target area of the location.

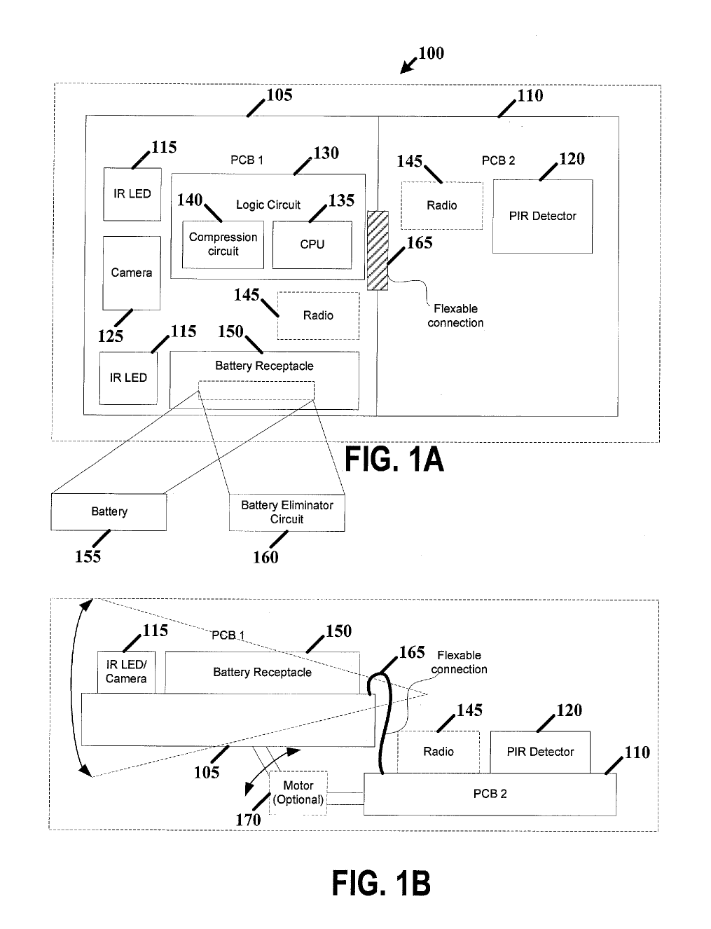

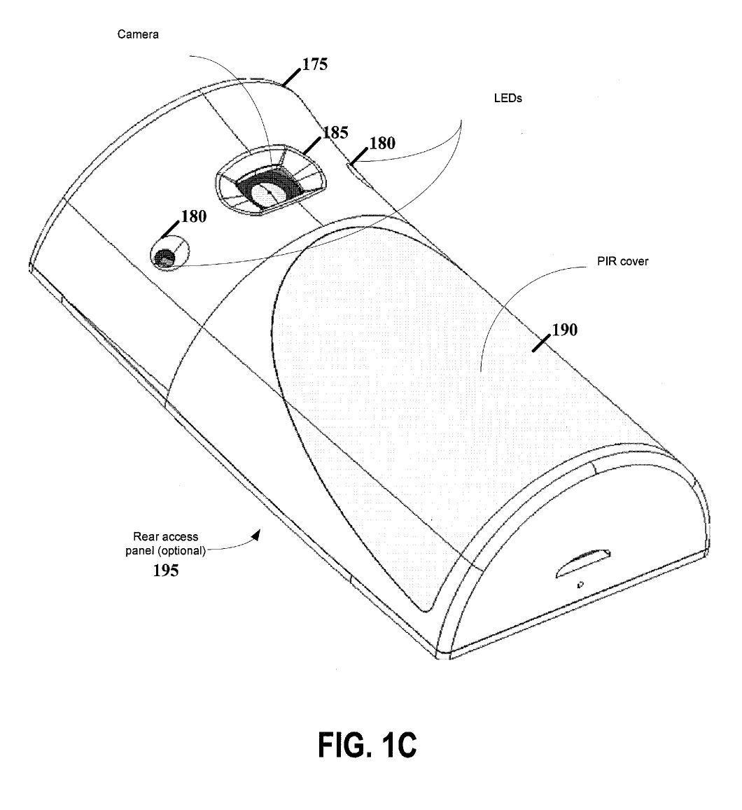

Turning to the figures, FIG. 1A shows a top down view of an apparatus 100 including multiple printed circuit boards, consistent with various aspects of the present disclosure. FIG. 1A shows a first printed circuit board 105 and a second printed circuit board 110. Each of the first printed circuit board 105 and the second printed circuit board 110 includes circuitry that is used for security monitoring. As is shown, for example, the first printed circuit board 105 includes circuitry for control and powering of at least one infrared LED 115. The infrared light emitting diode(s) 115 are provided in the housing of the apparatus 100, denoted by the exterior dotted line including both the first printed circuit board 105 and the second printed circuit board 110, that provide for night illumination. In this manner, a PIR detector 120, as is controlled and powered by circuitry on the second printed circuit board 110, can provide motion detection capabilities in both the day time and the night time. In response to the PIR detector 120 detecting movement, a camera 125, provided in the housing of the apparatus 100, will turn on and capture images or video of the area that is being monitored. The first circuit board 105 includes circuitry for control and powering of the camera 125. The images captured by the camera 125 are provided to logic circuitry 130, located on the first printed circuit board 105. The logic circuitry 130 includes a CPU 135 (such as a microprocessor) that can process and further compress the images, using a compression circuit 140, for wireless-transmission to a control unit or control station. The wireless-transmission is provided by a radio circuit 145 on the first printed circuit board 105 and can be transmitted using such signals as radio-frequency, Wi-Fi, Bluetooth, or any other suitable transmission medium. Alternatively, the radio can be located on the second circuit board 110.

The apparatus 100 includes a battery receptacle 150 configured to provide power from a battery 155 or by a battery eliminator circuit 160 (in some embodiments) to one or more circuits disposed on the first and/or second printed circuit board 105/110. One or more batteries (such as a lithium ion battery) provide power to all of the circuitry of the first and second printed circuit board 105/110. Additionally, when power is available, a battery eliminator circuit 160 can be wired to a power source such that the apparatus 100 does not require battery power. Any power source is suitable for powering the apparatus, including a solar power supply.

The first and second printed circuit boards 105/110, as shown in both FIGS. 1A and 1B, are connected by a flexible connection 165. This flexible connection 165 can be conductive. Additionally, in certain embodiments, each of the first and second printed circuit boards 105/110 and the flexible connection 165 are manufactured in the same step such that the first and second printed circuit boards 105/110 are provided with circuitry, each on one side of the boards. Additionally, the first and second printed circuit boards 105/110 and the flexible connection 165 can be cut from the same base circuit board. This provides for additional cost savings.

FIG. 1B shows a side view of an apparatus 100 including multiple printed circuit boards, consistent with various aspects of the present disclosure. FIG. 1B shows that the first and second printed circuit boards 105/110 are vertically offset from each other. Additionally, at least one of the first printed circuit board 105 and the second circuit board 110 can be rotated and adjusted with respect to the other of the circuit boards 105/110. In this manner, for example, the PIR detector 120 can be provided with a larger field of view in order to monitor a greater area for motion detection. The printed circuit board having the adjustable/rotating feature can be adjusted and rotated by a motor 170, which is also provided in the housing of the apparatus 100. Further, although FIG. 1B shows the first circuit board 105, the rotating/adjustable board, including circuitry of the infrared LED(s) and camera, in other embodiments, the PIR detector and circuitry can be provided on the rotating/adjustable board.

FIG. 1C shows an exterior apparatus, consistent with various aspects of the present disclosure. The apparatus exterior provides a housing 175 the printed circuit boards as is described with reference to FIGS. 1A and B. The housing 175 includes left and right apertures 180 for respective infrared LEDs 115. The housing 175 also includes a center aperture 185 for a camera 125. The housing 175 includes a cover 190 for the PIR circuit 120 that is configured to facilitate infrared detection performed by the PIR circuit. In some embodiments, the housing may include an access panel 195 (e.g., rear access panel) to provide access to controls and/or a battery.

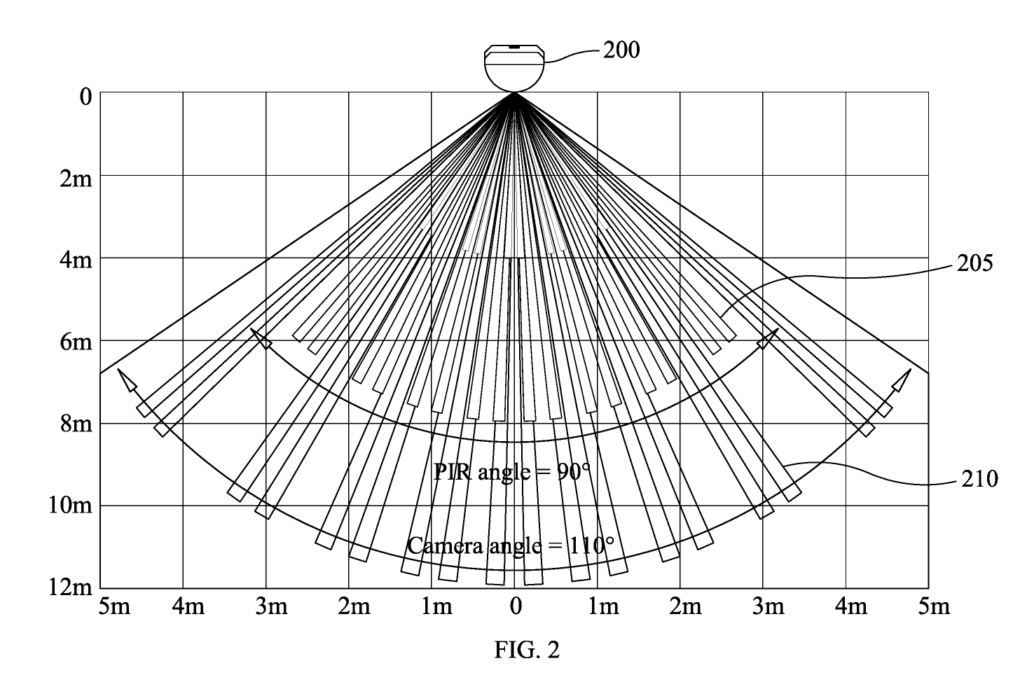

FIG. 2 shows an example security monitoring device 200, sensing range of a passive infrared sensor, and a camera contained within the security monitoring device, consistent with various aspects of the present disclosure. The security monitoring device/apparatus 200 is shown at the top of the figure. The various different ray diagrams show the range and field of view of both a PIR 205 and camera 210 contained within the security monitoring device 200. The passive infrared sensor (PIR) has a field of view of up to 90 degrees, and/or the camera has a field of view of up to 110 degrees. However, the rotating/adjustable board allows for an expanded field of view of one or more of the PIR and the camera if the rotating/adjustable board includes circuitry and those features. Also shown in FIG. 2 is the sensing distance of the PIR and the camera. The PIR has a view distance of up to 8 meters, and the camera has a field of view of up to 12 meters.

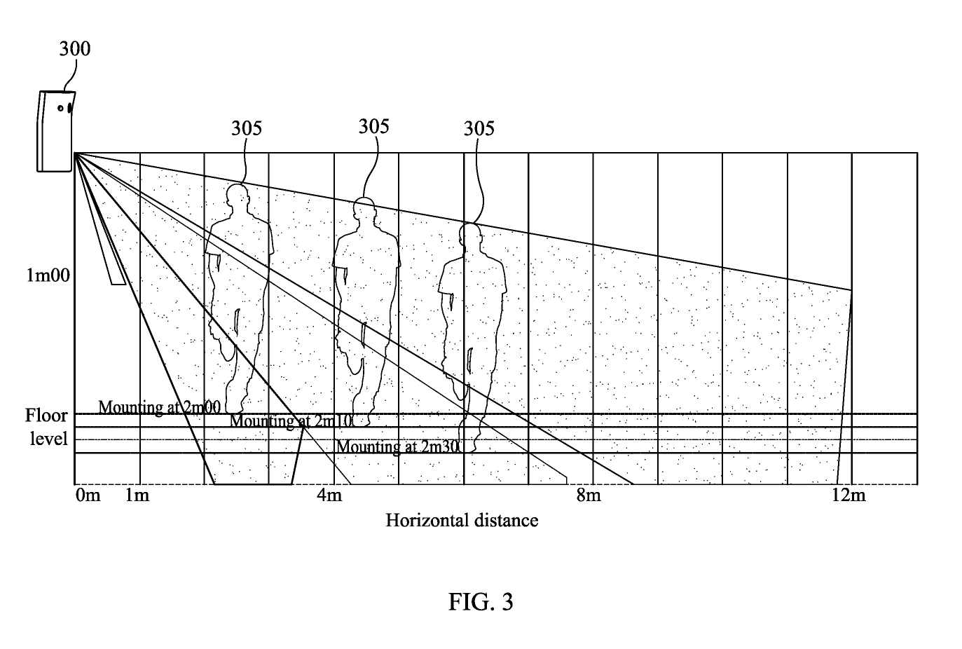

FIG. 3 shows another example security monitoring device 300 and sensing range of a passive infrared sensor and a camera contained within the security monitoring device, consistent with various aspects of the present disclosure. FIG. 3 also demonstrates the expanded field of view due to a rotating/adjustable board. The rotating/adjustable board allows for sensing of a person 305 at different heights. In this manner, an intruder could still be detected if that person is crawling or crouching in order to avoid detection.

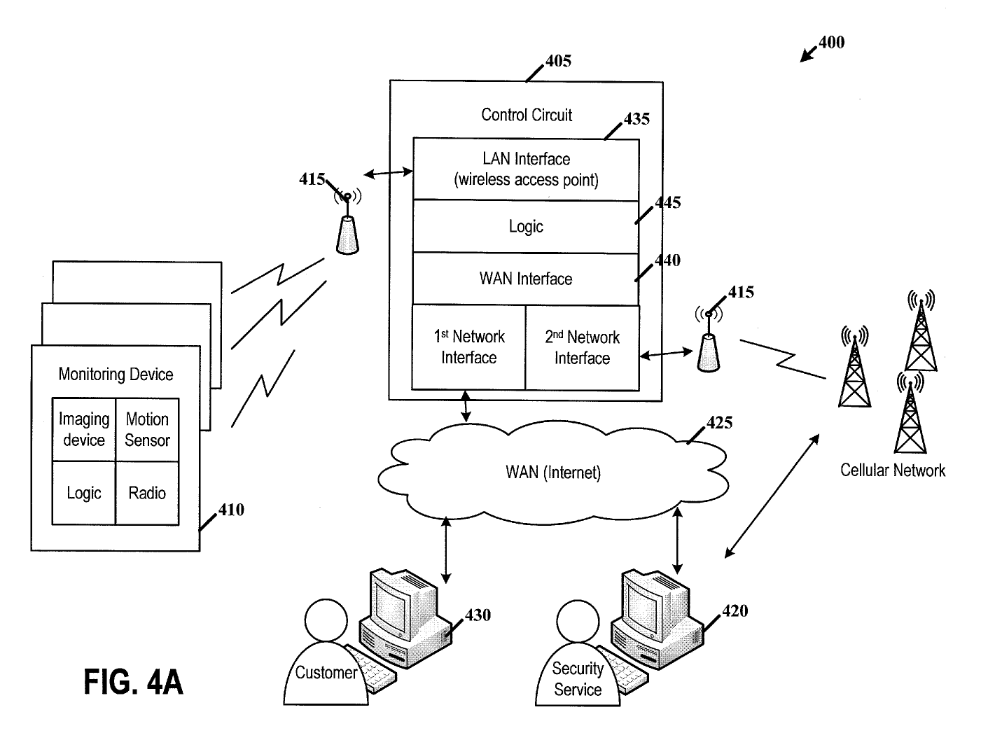

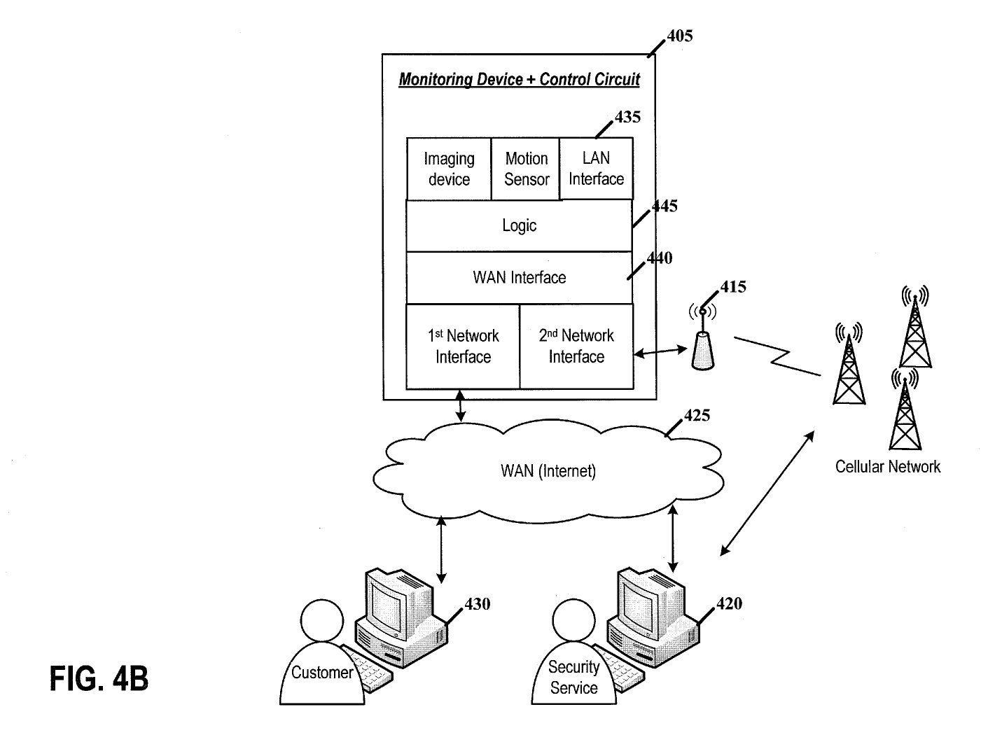

FIG. 4A shows an example security system 400 with controlled remote video access, consistent with various aspects of the present disclosure. The system 400 includes a control circuit 405 and one or more monitoring devices 410 (such as those discussed with reference to FIGS. 1A, 1B, and 1C) that capture video data. The control circuit 405 is configured to receive video signals from one or more of the monitoring devices 410 over a local area network (LAN) 415 and allow a first user, such as a security service 420, remote access to the video signals over a wide area network (WAN) 425, such as the Internet, in response to an alarm. In some embodiments, if the system 400 is not in an alarm state, the control circuit 405 is configured to deny the first user remote access to the video signals. In some embodiments, the control circuit 405 may be configured to allow a second user, such as a customer 430, remote access to the video signals via the WAN 425 regardless of whether the system 400 is operating in an alarm state or not.

In this example, the control circuit 405 includes a LAN interface 435, a WAN interface 440, and a logic circuit 445 coupled to the LAN and WAN interfaces 435/440. The LAN interface 435 is configured and arranged to facilitate communication between the logic circuit 445 and the one or more of the monitoring devices 410. The WAN interface 440 is configured to facilitate communication between remote users 420/430 and the logic circuit 445. The logic circuit 445 receives and processes video signals generated by the monitoring devices 410 and allows remote users 420/430 access to the video signals based on permissions that are dependent on an alarm state of the system.

FIG. 4B shows a security system similar to that shown in FIG. 4A but with a monitoring device integrated with the control circuit 405. In some embodiments, other circuits may be integrated with the monitoring device and/or control circuit as well.

In different implementations of the system shown in FIGS. 4A and 4B, remote access may be initiated using a number of different mechanisms. For example, in some implementations, the logic circuit 405 may be configured to allow or deny remote access in response to a request for remote access received from a user or via the WAN interface 440. In some other implementation, the logic circuit 405 may be configured to allow remote access by automatically transmitting the video signals to a specific user in response to a trigger event. For example, the logic circuit 405 may be configured to automatically transmit video to the security service in response to an alarm. When remote access is allowed, the logic circuit 405 may be configured to transmit video signals to a user in any number of different video formats, which may include streaming and/or non-streaming video formats.

The security system may implement or operate in conjunction with a number of different user interfaces for a user to request remote video access and/or adjust security settings of the system. In one or more embodiments, the system may be configured to host a server (not shown) at an assigned static or dynamic IP address. The server functions as a gateway between the LAN, where the control circuit resides, and the WAN, where a remotely-accessing user resides. The software identifies whether an incoming communication to the static IP address of the server is a user request to access the security system.

In one or more other embodiments a third party (e.g., a security firm) may operate an intermediary system located in the WAN that facilitate communication between a remote user and the system. The intermediary system may host a web-server or data server to provide a user interface as described above. Data requests sent from a remote user may be forwarded to the system and video (and other security parameters) provided from the security system may be forwarded to the remote user. In one implementation, the security system is configured to host a data server configured to operate in conjuncture with a customized software running on the intermediary system. In another implementation, the security system is configured to operate a customized client application configured to log into a data server operated by the intermediary system. The example user interface systems described above are provided for discussion purposes. It is recognized that the security system may be implemented to provide remote access by other means as well.

The remote user interface provided by the system may provide a number of different services to an authenticated user. For example, in addition to remote video access, one or more implementations of the user interface may allow the remote user to view status or activity logs of the monitoring devices (e.g., intrusion detectors, motion sensors, etc.), alarm state of the system, power usage, reposition angle of view of monitoring devices, etc. In one or more embodiments, authorized users may be able to modify security settings or the state of the control circuit and/or monitoring devices. As one example, a user may be able to remotely arm or disarm the system. As another example, if a monitoring device is configured to disable imaging device unless motion is detected by the motion sensor (e.g., a PIR detection circuit), the user interface may allow the user to enable the imaging device even if no motion is detected.

The system may include a number of different monitoring devices. In this example, the system includes an intrusion sensor (e.g., door/window contacts or glass-break detectors), an imaging device, and a monitoring device that incorporates an imaging device and a motion sensor (e.g., a PIR detection circuit). The imaging devices generate video signals that may be transmitted to the logic circuit.

In one or more embodiments, the system may be configured to enable and disable one or more of the monitoring devices in response to intrusion conditions. For example, a system user may set up zones with at least one intrusion sensor for each zone around the perimeter of a facility and set up corresponding imaging devices or other monitoring devices in the interior of the facility. Intrusion sensors may be activated (armed) by a system user using a control interface (not shown), e.g., a keypad on a security panel, a remote control fob, a phone call with dual-tone multi-frequency (DTMF), or smart phone application. This allows for a complete activation of the system when the system user leaves the facility as well as a partial perimeter activation of the facility when the system user (or other authorized person) is present. The system may disable one or more monitoring devices in an area and enable those devices in response to an intrusion signal generated by the intrusion sensor when an intrusion is detected. In this manner, power may be saved by not operating some of the monitoring devices unless an intrusion is detected at the perimeter of an area. In various implementations, the intrusion signal may be used to inform the control circuit or one or more peripheral devices, which may be configured to take action in response to the intrusion signal.

Similarly, monitoring device and/or control circuit may selectively enable the imaging device when motion is detected by the motion sensor. In this manner, power may be saved. For further information regarding monitoring devices including monitoring devices which have an integrated motion detector and image-capture device, reference may be made to U.S. Pat. No. 7,463,146, entitled “Integrated Motion-Image Monitoring Method and Device,” which is herein fully incorporated by reference. The aspects discussed therein may be implemented in connection with one or more of embodiments and implementations of the present disclosure (as well as with those shown in the figures).

The LAN interface may communicate with the monitoring devices using a number of different LAN architectures and or protocols. In one implementation, the LAN is set up using a centralized architecture. For example, the LAN interface can be configured to operate as a wireless access point for the various security devices. In another implementation, the security devices are configured without a centralized access point using ad hoc protocol, such as ZigBee™. Ad hoc protocols can be particularly useful as each security device does not necessarily need to be able to directly communicate with the control panel. Rather, communications can be passed between security devices before reaching the control panel. This can result in an increase in the effective range of the security devices, relative to the control panel, without a corresponding increase in transmission power.

For ease of illustration, the embodiments and examples are primarily described with reference to a LAN interface that implements a wireless protocol to communicate with the monitoring devices over a centralized wireless LAN, where the LAN interface operates as a wireless access point for the monitoring devices. Each of the monitoring devices may be configured with LAN-IP addresses (e.g., using either Dynamic Host Configuration Protocol (DHCP) or statically-assigned LAN IP addresses). However, the envisioned embodiments are not so limited and may implement the LAN interface to communicate with the monitoring devices using a wired LAN and/or decentralize architecture as well. In this example, the LAN interface is configured to communicate with the peripheral monitoring devices using a wireless communication protocol represented by the jagged lines found between the control circuit and the monitoring devices. The wireless communications may be implemented using suitable frequencies. For instance, wireless communications frequencies in residential, industrial, scientific and medical (ISM) radio bands (e.g., 900 Mhz, 2.4 Ghz and 5.8 Ghz) have been found to be suitable for security systems; however, alternate frequencies may be implemented in accordance with the particulars of the system or its intended implementation. For security purposes, video signals transmitted from the monitoring devices to the control circuit may be encrypted before being transmitted to the control circuit. For some example implementations related to wireless communication to and from monitoring devices, reference may be made to U.S. Pat. No. 7,835,343 filed on Mar. 24, 2006, entitled “Spread Spectrum Communications for Building-Security,” which is fully incorporated by reference herein. The aspects discussed therein may be implemented in connection with one or more of embodiments and implementations of the present disclosure (as well as with those shown in the figures).

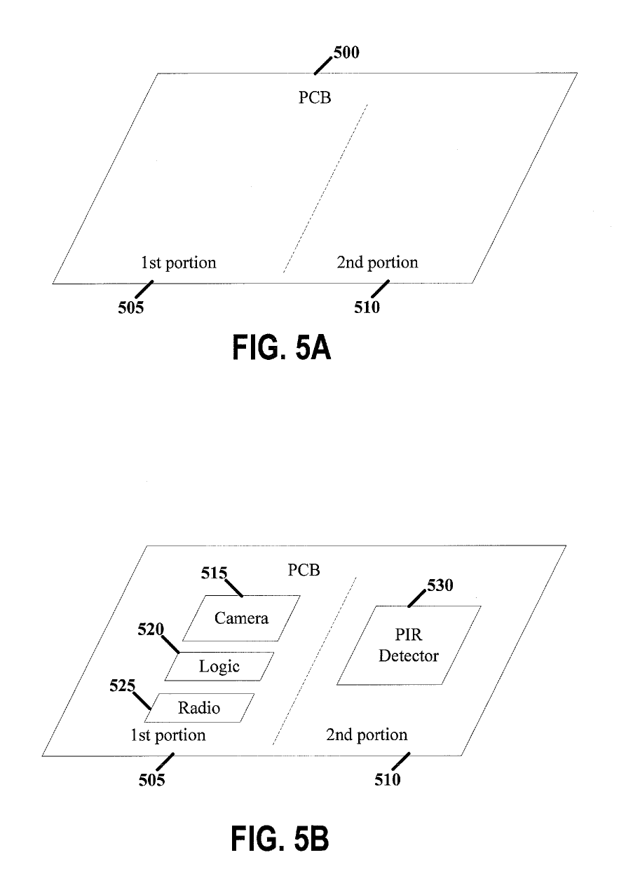

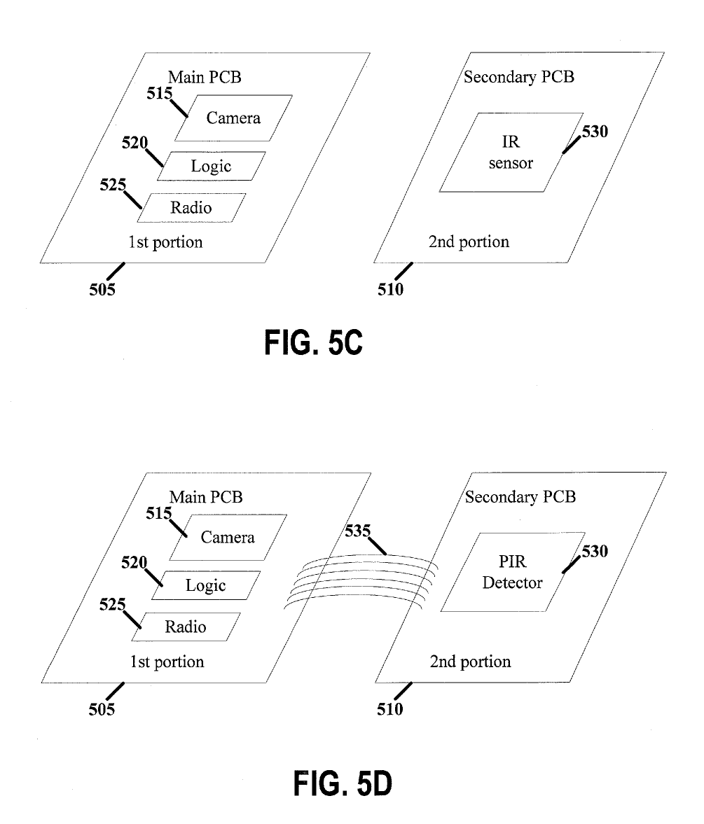

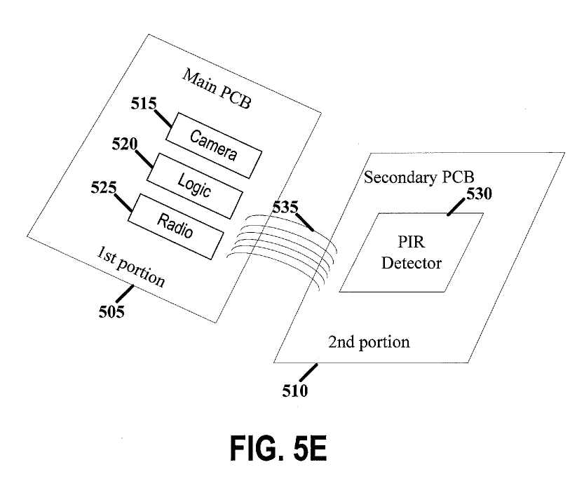

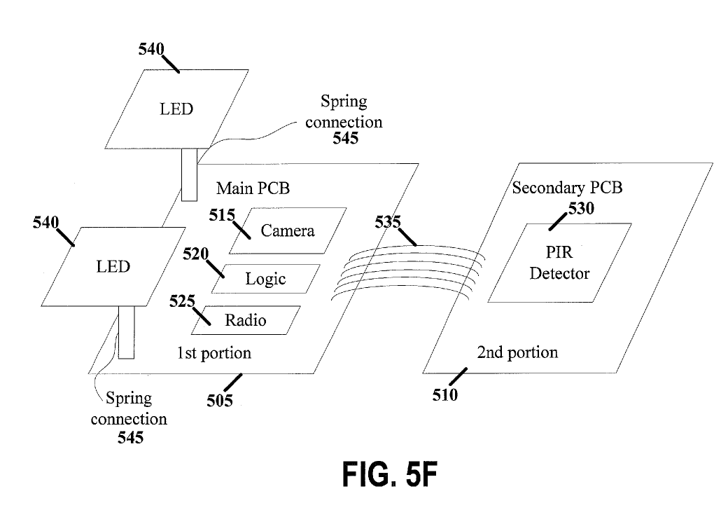

FIGS. 5A-F show example printed circuit board structures, consistent with various aspects of the present disclosure. FIG. 5A shows a printed circuit board 500 including a first portion 505 and a second portion 510. FIG. 5B shows the first and second portions 505/510 of the printed circuit board 500 including circuitry directed toward various aspects of the security apparatus discussion herein, including, for example, a camera 515, logic circuitry 520, radio circuitry 525, and a passive infrared sensor 530. FIG. 5C shows the first and second portions 505/510 of the printed circuit board of FIGS. 5A-B split in to two distinct printed circuit boards. FIG. 5D shows the first and second printed circuit boards 505/510, shown in FIG. 5C, connected by a flexible connector 535. FIG. 5E demonstrates the flexibility of the flexible connector 535, such that the first and second printed circuit boards 505/510 can be arranged as desired. For instance, in certain embodiments, the circuitry of both the first and second printed circuit boards 505/510 are faced out of a housing of the apparatus in the same direction as the camera and passive infrared sensor contained therein. FIG. 5F shows the first and second printed circuit boards 505/510 with mounted infrared LEDs 540. In some embodiments, the infrared LEDs 540 can be mounted by a spring connection 545 to allow for positioning of the infrared LEDs 540 into a housing. In some embodiments, infrared LEDs 540 are soldered directly to the printed circuit board 500. In some embodiments, the infrared LEDs 540 are placed on respective printed circuit boards that are connected to the first printed circuit board 505.

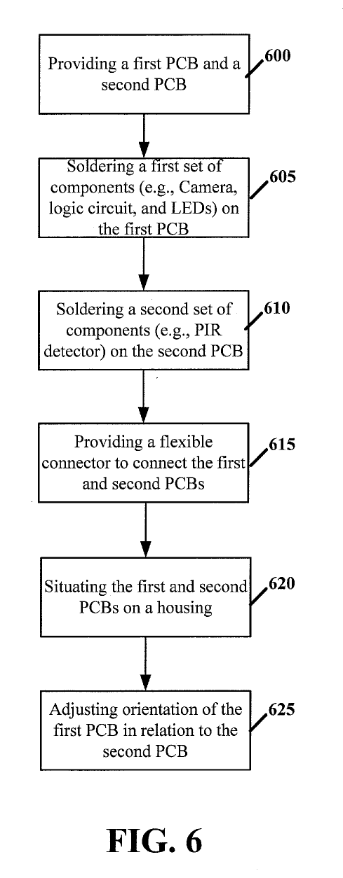

FIG. 6 shows a flowchart of an example method of manufacture, consistent with various aspects of the present disclosure. A first PCB and a second PCB are provided (600). A first set of components (e.g., a camera, a logic circuit, and LEDs) are soldered on the first PCB (605). A second set of components (e.g., PIR detector) are soldered on the second PCB (610). A flexible connector is provided to connect the first and second PCBs (615). The first and second

PCBs are situated on a housing (620). Orientation of the first PCB is then adjusted in relation to the second PCB (625).

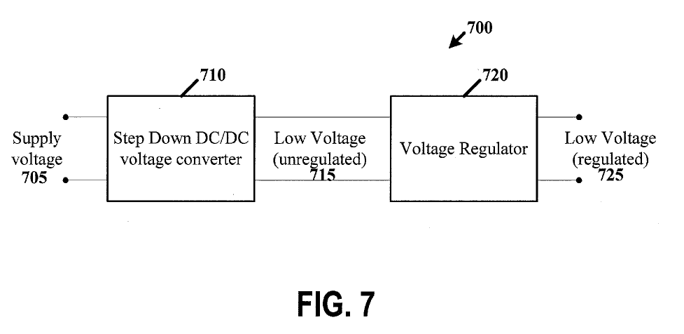

FIG. 7 shows an example battery elimination circuit 700, consistent with various aspects of the present disclosure. The battery elimination circuit 700 can be provided to apparatus of the present disclosure in lieu of a battery, e.g., to connect the apparatus to an external power supply. The battery elimination circuit 700 is connected to a supply (high) voltage 705. The battery terminal elimination circuit 700 passes the supply voltage 705 through a step down DC/DC voltage converter 710 (e.g., a TPS62110 step down converter by Texas Instruments) and provides a low voltage that is unregulated 715. This low voltage 715 is passed through a voltage regulator 720 (e.g., a ADP124 regulator by Analog Devices), and a regulated low voltage 725 is provided to a connected apparatus via the battery terminal interface circuit. In some embodiments, the battery elimination circuit 700 may be implemented with a single regulator circuit configured to provide a regulated voltage directly from a supply voltage 705.

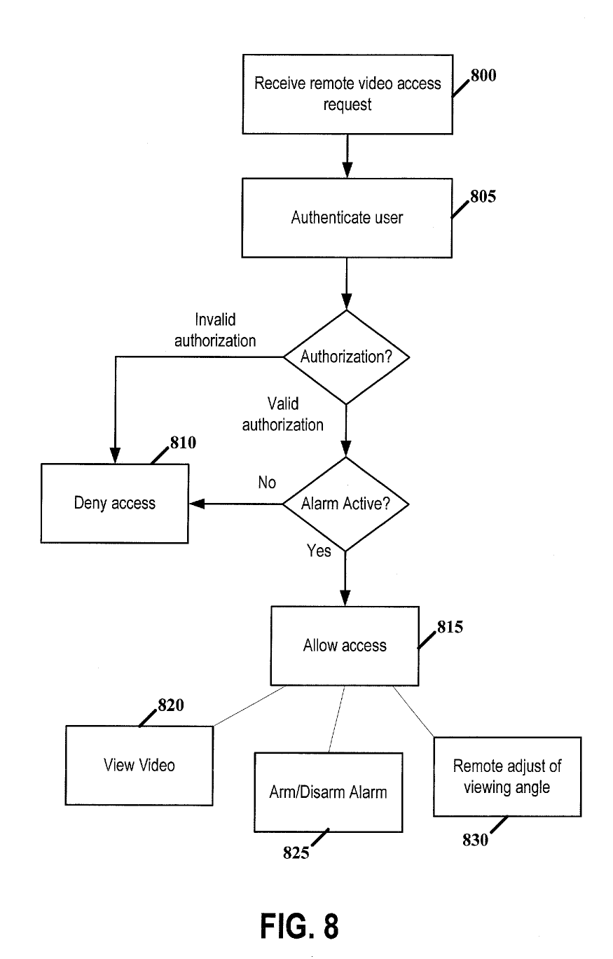

FIG. 8 shows an example operational flowchart, consistent with various aspects of the present disclosure. Various aspects of the present disclosure allow for a user to remotely access the monitoring device/apparatus. The monitoring device/apparatus will receive a remote video access request (800). The request can originate, for example, from an application on a mobile phone or from a computer. The monitoring device/apparatus will then operate to authenticate the user (805). If the monitoring device/apparatus determines that authorization is invalid, access will be denied (810). If the alarm is not active, access will be denied by the monitoring device/apparatus (810). If the alarm is active, the monitoring device/apparatus will allow access (815). At this point, the user can view current video or images captured by the monitoring device/apparatus (820), the user can arm or disarm the monitoring device/apparatus (825), and/or the user can adjust the angles of passive infrared sensor, the infrared light emitting diodes, and/or the camera of the monitoring device/apparatus (830).

Various aspects of the present disclosure are directed toward a main printed circuit board and another printed circuit board, each having circuitry, that share a common field of view. The printer circuit boards can also include one or both of a camera arrangement and a PIR sensor. Thus, the camera arrangement and the PIR sensor would also share a common field of view. Additionally, in certain embodiments, the field of view is adjusted relative to the other of the main printed circuit board and the other printed circuit board and therein adjusting the common field of view.

Various aspects of the present disclosure are also directed toward an intrusion sensor to sense an intrusion at a target area of a facility operating with a security monitoring apparatus, consistent with various aspects of the present disclosure. For some example implementations related to the intrusion sensor, reference may be made to U.S. Pat. No. 7,463,145 filed on Mar. 24, 2006, entitled “Security monitoring arrangement and method using a common field of view,” which is fully incorporated by reference herein. The aspects discussed therein may be implemented in connection with one or more of embodiments and implementations of the present disclosure (as well as with those shown in the figures).

Various aspects of the present disclosure are also directed toward a security system which uses a controller to communicate with security-monitoring devices. For some example implementations related to these aspects, reference may be made to U.S. Pat. No. 8,081,073 filed on Dec. 5, 2008, entitled “Integrated motion-image monitoring device with solar capacity,” which is fully incorporated by reference herein. The aspects discussed therein may be implemented in connection with one or more of embodiments and implementations of the present disclosure (as well as with those shown in the figures).

Various aspects of the present disclosure are also directed toward wireless communication between a central device and monitoring devices that utilize a limited power source. For some example implementations related to monitoring devices that utilize a limited power source, reference may be made to U.S. Pat. No. 8,155,105 filed on Mar. 24, 2006, entitled “Spread spectrum wireless communication and monitoring arrangement and method,” which is fully incorporated by reference herein. The aspects discussed therein may be implemented in connection with one or more of embodiments and implementations of the present disclosure (as well as with those shown in the figures).

Various aspects of the present disclosure are also directed toward allowing a user remote access to aspects of a monitoring device. For some example implementations related to user access, reference may be made to U.S. Patent Publ. No. 2013/0033379 filed on Aug. 5, 2011, entitled “Security Monitoring System,” which is fully incorporated by reference herein. The aspects discussed therein may be implemented in connection with one or more of embodiments and implementations of the present disclosure (as well as with those shown in the figures).

For further details regarding security systems and multiple printable circuit boards, reference is made to U.S. Provisional Patent Application Ser. Nos. 61/810,245 and 61/810,247, to which this document claims priority benefit of, and filed on Apr. 9, 2013; these patent documents are fully incorporated herein by reference.

While one of the printed circuit boards described herein can be considered a main printed circuit board and the other a secondary printed circuit board, they of course can be switched.

Various modules and/or other circuit-based building blocks may be implemented to carry out one or more of the operations and activities described herein and/or shown in the figures. In such contexts, a “module” is a circuit that carries out one or more of these or related operations/activities. For example, in certain of the above-discussed embodiments, one or more modules are discrete logic circuits or programmable logic circuits configured and arranged for implementing these operations/activities, as in the circuit modules shown in the Figures. In certain embodiments, the programmable circuit is one or more computer circuits programmed to execute a set (or sets) of instructions (and/or configuration data). The instructions (and/or configuration data) can be in the form of firmware or software stored in and accessible from a memory (circuit). Further, it would be understood that the various aspects, including for instance the dual-printed circuit board with the flexible connector there between, is not necessarily limited to monitoring devices and/or Passive infrared detector monitoring devices. For instance, in other embodiments, the light emitting and/or light detecting aspects are secondary, and other emissions/detection mechanisms are used such as, for example, audio sensing, light sensing, humidity sensing, moisture sensing, and environmental sensing. The various aspects illustrated and claimed herein are used with or part of the monitoring device including for example two printed circuit boards manufactured and connected as described above, but with different components on each.

Based upon the above discussion and illustrations, those skilled in the art will readily recognize that various modifications and changes may be made to the present disclosure without strictly following the exemplary embodiments and applications illustrated and described herein. For example, the input terminals as shown and discussed may be replaced with terminals of different arrangements, and different types and numbers of input configurations (e.g., involving different types of input circuits and related connectivity). Such modifications do not depart from the true spirit and scope of the present disclosure, including that set forth in the following claims.

What is claimed is:

1. A method of forming a circuit board assembly, comprising:
providing a base circuit board;
forming a first circuit board from the base circuit board;
forming a second circuit board from the base circuit board; and
forming a flexible connector from the base circuit board, the flexible connector connecting the first circuit board to the second circuit board.

2. The method of claim 1, further comprising depositing circuitry on the first circuit board, the second circuit board, and the flexible connector.

3. The method of claim 2, wherein the circuitry is deposited only on one corresponding side of the first circuit board, the second circuit board, and the flexible connector.

4. The method of claim 2, wherein the circuitry electrically couples the first circuit board to the second circuit board by way of the flexible connector.

5. The method of claim 3, wherein the first circuit board, second circuit board, and flexible connector are formed in the same process step.

6. The method of claim 1, wherein the flexible connector is electrically conductive.

7. The method of claim 1, further comprising depositing a varnish layer on a circuitry-containing side of the first circuit board and the second circuit board, the varnish layer being configured and arranged to protect the m first circuit board and the second circuit board against environmental elements.

8. The method of claim 1, further comprising disposing the first circuit board, the second circuit board and the flexible connector into a security monitor housing.

9. The method of claim 8, wherein the method further comprises providing the first circuit board with a first-type sensor circuitry.

10. The method of claim 9, wherein the method further comprises providing the second circuit board with a second-type sensor circuitry.

11. The method of claim 10, wherein the sensor circuitry of at least one of the first circuit board and the second circuit board includes a passive infrared (PIR) sensor disposed thereon that is adjustable with respect to the other circuit board.

12. The method of claim 10, wherein the sensor circuitry of at least one of the first circuit board and the second circuit board is configured and arranged to interact with a wide angle lens, infrared light emitting diodes (LEDs), and further circuitry configured and arranged to transmit a status signal including monitoring information.

13. The method of claim 10, further comprising disposing an imaging circuit on one of the first circuit board and second circuit board, the imaging circuit being configured and arranged to capture images of a monitored area.

14. The method of claim 13, further comprising disposing compression circuitry on one of the first circuit board and second circuit board, the compression circuitry being configured to compress images captured by the imaging circuit, wherein the imaging circuit and compression circuitry are coupled to at least one of the first-type sensor circuitry and the second-type sensor circuitry.
